(19) United States
(12) Patent Application Publication
(10) Pub. No.: US 2004/0078251 A1
(43) Pub. Date: Apr. 22, 2004

(54) Dividing a travel query into sub-queries

(76) Inventor: Carl G. DeMarcken, Cambridge, MA (US)

Correspondence Address: DENIS G. MALONEY, Fish & Richardson P.C., 225 Franklin Street, Boston, MA, 02110-2804, US

(21) Appl. No.: 10/272,426

(22) Filed: Oct. 16, 2002

(51) Int. Cl. G06F 17/60

(52) U.S. Cl. 705/5; 705/1

(57) ABSTRACT

Techniques for dividing a travel query into sub-queries for execution by a travel planning system is described. The techniques can divide the travel query according to some optimization such as by taking query processing difficulty into consideration or loading on the travel planning system.

### BACKGROUND

This invention relates to travel scheduling and pricing, and more particularly to processing queries for air travel planning systems.

In travel planning such as for air travel scheduling, pricing and low-fare-search queries are posed by users from travel agent systems, airline reservation agent systems, travel web sites, and airline-specific web sites. Low-fare-search (LFS) queries typically include origin and destination information, time constraints and additional information including passenger profile and travel preferences. Travel planning computer systems respond to these LFS queries and typically return a list of possible tickets, each having flight and price information. Some systems return answers in a compact form such as through a pricing graph.

Travel planning systems expend considerable computational resources responding to LFS queries. It is not uncommon for a travel planning system to spend more than 30 seconds responding to an LFS query, even for a relatively straightforward round-trip query leaving and returning from specific airports on specific dates. Typically, a single computer will be devoted to answering such a query, though the computer may range from a small personal computer or workstation class machine to a mainframe computer.

Because travel planning systems spend considerable computational resources on each LFS query, and because many such queries are answered every second, it is typical for travel planning computer programs to be run on large “farms” of computers, including tens, hundreds or even thousands of computer processors. In current practice, each query is answered by a single computer with different computers in a farm concurrently working on corresponding different queries.

### SUMMARY

However, there are many situations in which it is advantageous for multiple computers to work on the same query concurrently. One reason for doing so is that the response time (“latency”) can be reduced. For example, where one computer might expend 1 minute answering a query, it may be possible for 4 computers acting in concert to each expend 15 seconds answering the same query. The total number of CPU-seconds is the same, but the query latency is reduced from 1 minute to 15 seconds, a considerable improvement from the user's standpoint.

Also, in many cases the peak load on the farm, which may only be reached for short periods, dictates the size of a computer farm. For example, it is common for load on travel planning systems to be high in the early work hours but much lower late at night and on weekends and holidays (when travelers are less likely to access the internet and travel agencies are closed). It may be that a travel planning system requires 1000 computers to support its query load during peak periods, but only 250 during off-peak hours. Since the incremental cost of using an otherwise idle computer is negligible, during off-peak hours it may be economically practical to devote 4 times the computing resources to answering a query as at peak hours. The extra resources may enable more complicated queries, or be used to improve the search accuracy. However, it may be preferred to use these resources in parallel to maintain low query latency, rather than having each computer spend four times longer on each query.

According to an aspect of the present invention, a method includes dividing a travel query into sub-queries for execution by a travel planning system to return answers that satisfy the travel query.

According to an additional aspect of the present invention a method includes dividing a travel query into sub-queries according to a determined optimal division of the query for execution by a travel planning system to return answers that satisfy the travel query.

Depending on the travel planning system, there may be different ways to divide up a low-fare-search query amongst several computers. For example, some travel planning systems solve low-fare-search problems by first enumerating a list of from 1 to several thousand possible flight combinations that satisfy the airport and time specifications. Such systems then iterate over each flight combination finding prices for each, and return a small set of flight combinations that have low prices. Because the process of finding prices is typically much more computationally expensive than finding flight combinations, for a travel planning system with such a design a practical way to divide the work amongst several computers would be to have one computer generate the list of flight combinations and to divide the list of flight combinations into smaller lists to be priced concurrently by multiple computers.

However, again depending on the design of the travel planning system, this strategy may be less efficient than other strategies. For example, a travel planning system that achieves computational advantages by sharing work across the pricing of multiple flight combinations can divide queries in certain ways amongst the computers in order to retain those efficiencies resulting from sharing work. Such ways include having each computer price flight combinations for a different airline or by dividing up queries by time range. For such a system it is less efficient in terms of total resources expended to price many flight combinations separately on different computers than to price many flight combinations as part of a single computational process.

When dividing a low-fare-search query amongst multiple computers it is advantageous to have each computer perform roughly equal amounts of work, since typically the slowest computer determines the response time of the entire query. It is desirable that any technique of dividing a query into sub-queries be sophisticated enough to base its decisions in part on the expected work necessary to solve each sub-query.

Because of resource or program limitations, a travel planning system may be incapable of answering queries beyond a certain level of difficulty. For example, a system may be limited to solving problems involving no more than one-day departure windows, or a single origin or destination. For such a system, queries that exceed the limits of the system may need to be divided into smaller “sub-queries.” Techniques for dividing a query into smaller sub-queries executed concurrently with the goal of reducing query latency can be used to extend the capabilities of those travel planning systems that have difficulties handling more complex travel queries.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of a travel planning system that divides search queries into sub-queries to be executed concurrently.

FIG. 2 is a flow chart of a query dividing process that is executed in a centralized manner.

FIG. 3 is a flow chart of a query dividing process that is executed in a distributed manner.

FIGS. 4-7 are flow charts depicting details of algorithms for dividing queries according to a specified criterion.

FIGS. 8-10 are flow charts depicting details of query division that takes into consideration loading on travel planning system.

### DETAILED DESCRIPTION

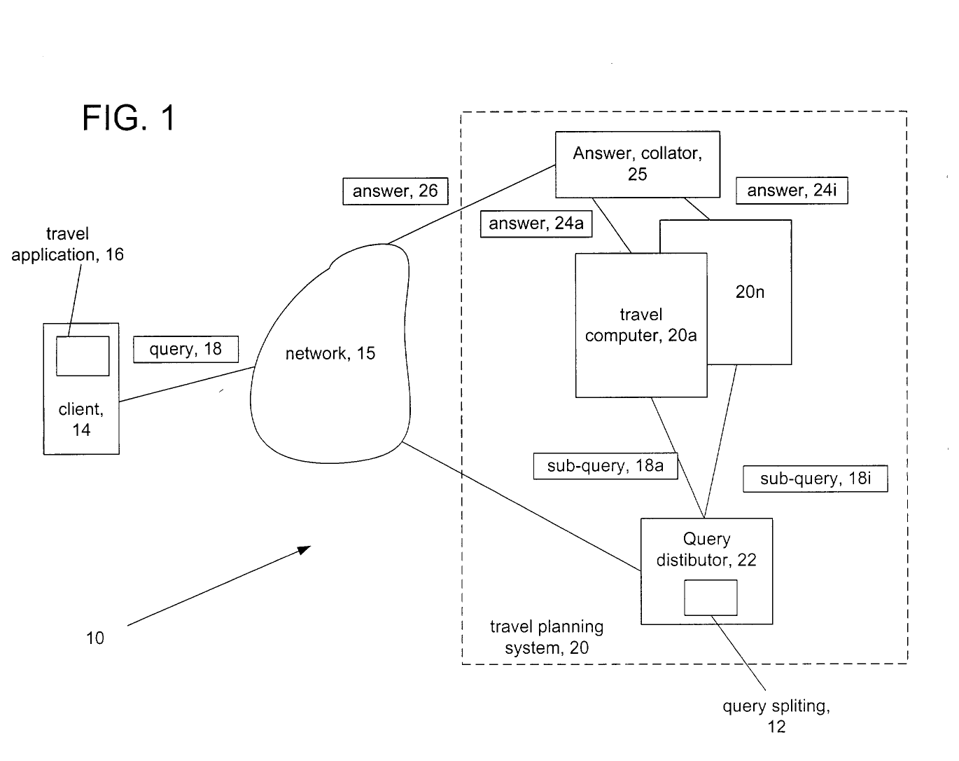

Referring to FIG. 1, an arrangement 10 for travel planning includes a process 12 to divide low-fare-search queries into sub-queries to be executed concurrently. A user such as a traveler, travel agent or airline reservation agent enters trip information typically including time and airport (i.e. origin and destination) information from a client system 14 into a travel application 16. The travel application 16 is typically accessed via the client system 14 which can be a travel agent terminal, an Internet web browser connected to a travel web site, and so forth. The travel application 16 composes this information into an appropriately formatted query, e.g., a low-fare-search query 18 that is fed via a network 15 to a travel planning system 20. Network 15 can be any type of network such as a public network such as the Internet or telephone system or a private network such as a local area network (LAN), wide area network (WAN), virtual private network (VPN), and so forth. The travel planning system 20 includes a query distributor 22 that alters the query 18 to produce sub-queries 18a-18i that are distributed to various travel planning computers 20a-20n, where n does not necessary have to be equal to i. The travel planning computers 20a-20n execute the sub-queries 18a-18i concurrently to produce answers 24a-24i. The answers 24a-24i to these sub-queries 18a-18i are sent back to the user. In one embodiment, the answers 24a-24i are sent to an answer collator 25, which merges the answers 24a-24i into a composite answer 26. Several merging techniques can be employed, such as returning all answers or selecting the cheapest answers from all the answers and so forth.

The answers for each sub-query may be collected and organized by the answer collator 25. If the form of the sub-query results is a simple list of travel options, the collation process used by the answer collator 25 may simply involve concatenating the answers from each sub-query. However more complex collations schemes are possible, such as selecting a subset of answers from each sub-query (possibly based on cheapest travel options from amongst all of the answers and so forth). Alternatively, if the query division process 12 produces sub-queries that overlap, the collation process 25 could remove duplicate answers. In the case where the travel planning computers produce answers in other forms, such as the pricing graph representation, other methods of collation may be used. For example, multiple pricing graphs can be merged into one by joining them with an OR node. It may also be that no collation process is used, so that answers for the different sub-queries are returned to the travel application as soon as they are available, rather than waiting for all sub-queries to complete.

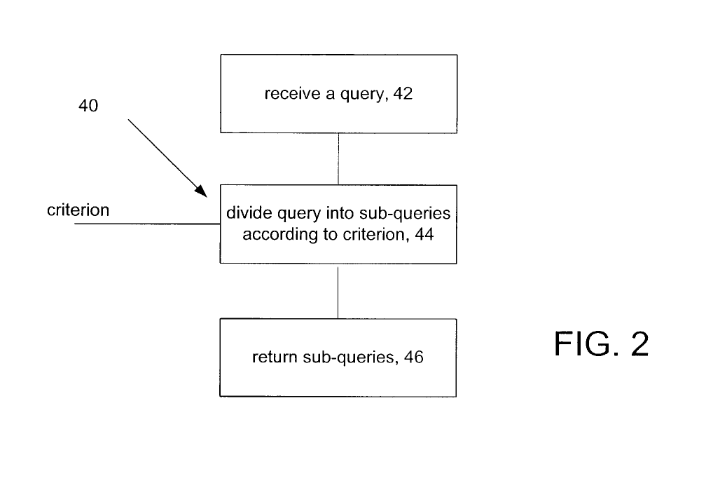

Referring to FIG. 2 a process 40 for dividing queries is shown. The process 40 receives 42 a query, e.g., a low fare search query. A low-fare-search query typically includes a sequence of specifications of origins, destinations, and travel time periods for each part of a trip. For example, a two-part round trip query might be described as:

| Part# | Origin | Destination | Departure Dates |
|---|---|---|---|
| 1 | BOS | SFO or SJC | August 17th-August 18th |
| 2 | SFO or SJC | BOS | August 23rd-August 30^{th} |

The process 40 divides 44 the query into sub-queries based on a criterion. There are many ways such a query could be divided into sub-queries. To reduce unnecessary work, it is typically advantageous to divide a query into sub-queries that do not overlap. For example, if dividing into at most 4 sub-queries, the following divisions of the query according to different criterion as set out in the examples below are all possibilities:

1. By destination airport (2 sub-queries)

| | | | |
|---|---|---|---|
| Part# | Origin | Destination | Departure Dates |

Sub-query 1:

| | | | |
|---|---|---|---|
| 1 | BOS | SFO | August 17th-August 18th |
| 2 | SFO | BOS | August 23rd-August 30th |

Sub-query 2:

| | | | |
|---|---|---|---|
| 1 | BOS | SJC | August 17th-August 18th |
| 2 | SJC | BOS | August 23rd-August 30th |

2. By outbound departure time (4 sub-queries)

| | | | |
|---|---|---|---|
| Part# | Origin | Destination | Departure Dates |

Sub-query 1:

| | | | |
|---|---|---|---|
| 1 | BOS | SFO or SJC | August 17th (0:00 to 13:59) |
| 2 | SFO | BOS | August 23rd-August 30th |

Sub-query 2:

| | | | |
|---|---|---|---|
| 1 | BOS | SFO or SJC | August 17th (14:00 to 23:59) |
| 2 | SFO | BOS | August 23rd-August 30th |

Sub-query 3:

| | | | |
|---|---|---|---|
| 1 | BOS | SFO or SJC | August 18th (0:00 to 13:59) |
| 2 | SFO | BOS | August 23rd-August 30th |

Sub-query 4:

| | | | |
|---|---|---|---|
| 1 | BOS | SFO or SJC | August 18th (14:00 to 23:59) |
| 2 | SFO | BOS | August 23rd-August 30th |

3. By outbound and return departure times (4 sub-queries)

| | | | |
|---|---|---|---|
| Part# | Origin | Destination | Departure Dates |

Sub-query 1:

| | | | |
|---|---|---|---|
| 1 | BOS | SFO or SJC | August 17th |
| 2 | SFO | BOS | August 23rd-August 26th |

Sub-query 2:

| | | | |
|---|---|---|---|
| 1 | BOS | SFO or SJC | August 17th |
| 2 | SFO | BOS | August 27th-August 30th |

Sub-query 3:

| | | | |
|---|---|---|---|
| 1 | BOS | SFO or SJC | August 18th |
| 2 | SFO | BOS | August 23rd-August 26th |

Sub-query 4:

| | | | |
|---|---|---|---|
| 1 | BOS | SFO or SJC | August 18th |
| 2 | SFO | BOS | August 27th-August 30th |

4. By airline (4 sub-queries)

| | | | |
|---|---|---|---|
| Part# | Origin | Destination | Departure Dates |

Sub-query 1:

| | | | |
|---|---|---|---|
| 1 | BOS | SFO or SJC | August 17th-August 18th |
| 2 | SFO | BOS | August 23rd-August 30th |

(all one-airline trips involving any of AA, CO, HP, DL)

Sub-query 2:

| | | | |
|---|---|---|---|
| 1 | BOS | SFO or SJC | August 17th-August 18th |
| 2 | SFO | BOS | August 23rd-August 30th |

(all one-airline trips involving any of UA, NW, US, WN)

Sub-query 3:

| | | | |
|---|---|---|---|
| 1 | BOS | SFO or SJC | August 17th-August 18th |
| 2 | SFO | BOS | August 23rd-August 30th |

(all one-airline trips involving any other airlines)

Sub-query 4:

| | | | |
|---|---|---|---|
| 1 | BOS | SFO or SJC | August 17th-August 18th |
| 2 | SFO | BOS | August 23rd-August 30th |

(all multi-airline trips)

5. By fares (3 queries)

| | | | |
|---|---|---|---|
| Part# | Origin | Destination | Departure Dates |

Sub-query 1:

| | | | |
|---|---|---|---|
| 1 | BOS | SFO or SJC | August 17th-August 18th |
| 2 | SFO | BOS | August 23rd-August 30th |

(all first class, business class, and refundable coach fares)

Sub-query 2:

| | | | |
|---|---|---|---|
| 1 | BOS | SFO or SJC | August 17th-August 18th |
| 2 | SFO | BOS | August 23rd-August 30th |

(all trips involving only refundable fares that start with the letters A-M)

Sub-query 3:

| | | | |
|---|---|---|---|
| 1 | BOS | SFO or SJC | August 17th-August 18th |
| 2 | SFO | BOS | August 23rd-August 30th |

(all trips involving only refundable fares that start with the letters N-Z)

6. By flight combination (4 queries)

| | | | |
|---|---|---|---|
| Part# | Origin | Destination | Departure Dates |

Sub-query 1:

| | | | |
|---|---|---|---|
| 1 | BOS | SFO or SJC | August 17th-August 18th |
| 2 | SFO | BOS | August 23rd-August 30th |

(after generating flight combinations, choose only even numbered
outbound and even numbered return possibilities)

Sub-query 2:

| | | | |
|---|---|---|---|
| 1 | BOS | SFO or SJC | August 17th-August 18th |
| 2 | SFO | BOS | August 23rd-August 30th |

(after generating flight combinations, choose only even numbered
outbound and odd numbered return possibilities)

Sub-query 3:

| | | | |
|---|---|---|---|
| 1 | BOS | SFO or SJC | August 17th-August 18th |
| 2 | SFO | BOS | August 23rd-August 30th |

(after generating flight combinations, choose only odd numbered
outbound and even numbered return possibilities)

Sub-query 4:

| | | | |
|---|---|---|---|
| 1 | BOS | SFO or SJC | August 17th-August 18th |
| 2 | SFO | BOS | August 23rd-August 30th |

(after generating flight combinations, choose only odd numbered
outbound and odd numbered return possibilities)

After dividing the query into sub-queries the process returns 46 the sub-queries. Though it may be desirable, it is not necessary for the sub-queries to exactly replicate the original query. Example 5, for instance, does not allow for mixtures of refundable and non-refundable coach-class fares.

For a particular travel planning system or low-fare-search query there may be advantages to particular ways of dividing queries. For example, for a travel planning system that shares work across dates it may be less desirable to divide the query by date or time than by airports, airline, fares or flights.

When dividing a query into sub-queries it may be desirable to produce sub-queries that involve approximately the same amount of work, so that total query latency is minimized. This does not necessarily correspond to equally sized query units. For example, since airlines vary widely by the number of flight combinations and fares they offer between any set of origins and destinations, it may require more computational expense to search over one airline than another. As another example, it may be that because of fare rule details, a query that spans a Saturday night takes more computational time than a query that does not involve a Saturday night stay, so two equal duration date or time ranges may result in unequal sub-query latency.

One place to provide the process to divide queries into sub-queries resides in the query distributor 22 (FIG. 1). While the query distributor is certainly one option, in typical travel planning systems the query distributor is a separate computer or computer program from the planing computers and may lack computational sophistication or flight and fare data necessary to optimally divide a particular query. It may be preferable for the travel planning computers 20a-20n to divide the query.

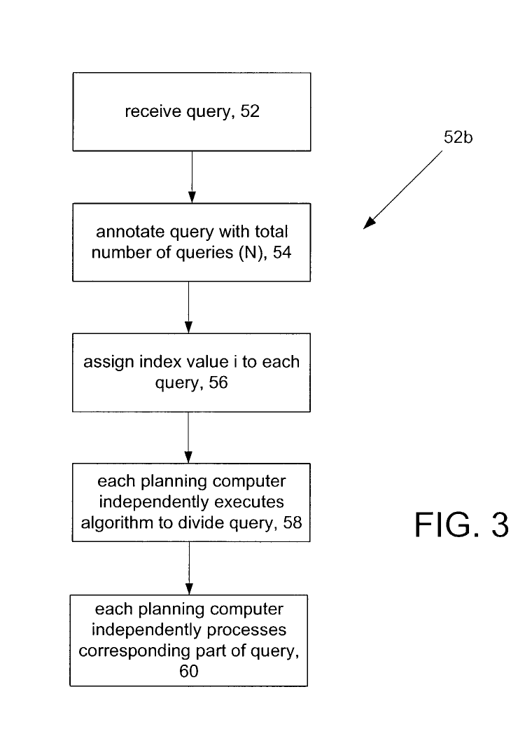

Referring to FIG. 3, a process 50 to have travel planning computers 20a-20n (FIG. 1) divide the query (FIG. 1) is shown. The distributor 22 receives 52 the query 18 and generates sub-queries by annotating 54 the original query 18 with the total number of sub-queries N and assigns 56 an index (i) to a sub-query i. Then each planning computer 20a-20i can independently execute 58 the same algorithm to divide the original query into N parts; the computer executing the i′^{th} sub-query selects the corresponding i′^{th} part of the divided query 18 to process. In this way each planning computer works on a separate part of the original query without an explicit communication among the planning computers.

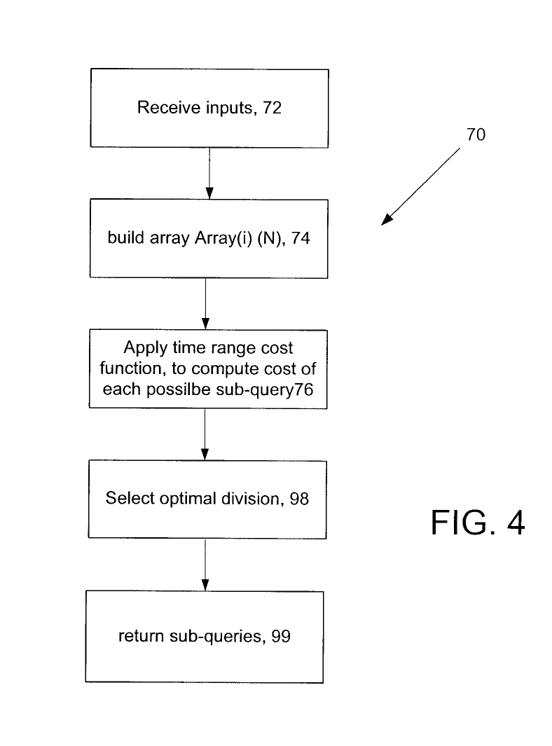

Referring to FIG. 4, a process 70 for dividing a query according to a single time range is shown. The process 70 receives 72 as inputs earliest time specified in the query, latest time specified in the query, and maximum number of sub-queries. The process 70 uses a Viterbi algorithm to build 74 an array Array(i) (N) of best division of time range from query earliest time to i into N sub queries. The process 70 uses 76 a time range cost function time_range_cost( ) to compute a cost of each possible sub-query. Using the values of array(query latest time)( ) the process 70 selects 78 an optimal division of the query into sub queries over an entire period specified by the query and returns 79 the sub-queries.

As an example, the process 70 operates on a query with a long time range for some trip part, such as a flexible-date query “from BOS to LAX and back, departing any time in April, staying for about a week.” One approach is to divide the original query into sub-queries with non-overlapping outbound departure dates. However, it may be that different divisions have different costs; suppose, for example, that the travel planning computers are especially efficient if the time range they are presented with does not cross a Saturday night boundary. Then if 6 sub-queries are to be used, it might be best to divide April as follows, in order to eliminate those ranges, which include both a Saturday and a Sunday.

| Sun | Mon | Tue | Wed | Thu | Fri | Sat | |
|---|---|---|---|---|---|---|---|
| | | | 1 | 2 | 3 | 4 | sub-query 1 (Apr 1-4) |
| 5 | 6 | 7 | 8 | 9 | 10 | 11 | sub-query 2 (Apr 5-11) |
| 12 | 13 | 14 | 15 | 16 | 17 | 18 | sub-query 3 (Apr 12-18) |
| 19 | 20 | 21 | 22 | 23 | 24 | 25 | sub-query 4 (Apr 19-21) |
| | | | | | | | and 5 (22-25) |
| 26 | 27 | 28 | 29 | 30 | | | sub-query 6 (Apr 26-30) |

If a function time_range_cost( ) is defined that estimates the cost of a sub-query with a particular time range, this can be used to efficiently find the optimal division into sub-queries, using a variation of the Viterbi algorithm shown in a detailed example of the process 70 in Text Boxes 1 and 2 below:

Text Box 1

```
get_optimal_single_time_range_division(query_earliest_time,
                      query_latest_time,
                      max_subqueries)
{
  let query_time_range = query_latest_time − query_earliest_time;
  // best_cost_array[i][n] holds the lowest possible total cost of
  // dividing the time from query_earliest_time to
  // query_earliest_time+i−1 into n sub-queries
  // best_answer_array[i][n] holds a particular way of dividing the
  // time to achieve this cost
  let best_cost_array = array[query_time_range][max_subqueries+1];
  let best_answer_array = array[query_time_range][max_subqueries+1];
  best_cost_array[][] = infinity;
  best_cost_array[0][0] = 0;
  best_answer_array[0][0] = {};
  for (i from 0 to query_time_range) {
    for (j from i to query_time_range) {
      let time_window = pair(query_earliest_time+i,
                  query_earliest_time+j);
      let time_window_cost = time_range_cost(query_earliest_time+i,
                        query_earliest_time+j);
      for (n from 1 to max_subqueries) {
        let cost = best_cost_array[i][n−1] + time_window_cost;
        if (cost < best_cost_array[j][n]) {
          best_cost_array[j][n] = cost;
          best_answer_array[j][n] = append(best_answer_array[i][n−1],
                        time_window);
        }
      }
    }
}
```

Text Box 2

```
  // select out and return the number of sub-queries that results in the
  // lowest cost
  let best_cost = infinity;
  let best_answer = {};
  for (n from 1 to max_subqueries) {
    if (best_cost_array[query_time_range][n] < best_cost) {
      best_cost = best_cost_array[query_time_range][n];
      best_answer = best_answer_array[query_time_range][n];
    }
  }
  return best_answer;
}
time_range_cost(query_earliest_time, query_latest_time)
{
  let range = query_latest_time − query_earliest_time;
  let cost =
      CONSTANT_TERM +
      LINEAR_TERM * range +
      QUADRATIC_TERM * (range * range);
  return cost;
}
```

This algorithm efficiently finds the optimal division of the original query's time range into a variable number of sub-queries. If the time_range_cost( ) function has a fixed component (CONSTANT_TERM in the sample function), so that any time range no matter how small has a cost, then the algorithm will avoid dividing the original query into unnecessarily many sub-queries; this is important in the typical case where the travel planning computers use some resources no matter how small the sub-query. Conversely, if time₁₃ range_cost( ) has a non-linear component (the QUADRATIC_TERM in the sample function), then the algorithm will favor allocating the original time-range equally among sub-queries, so that total latency is minimized.

For example, if time is expressed in minutes and a single travel planning computer spends on average 10 seconds for every days worth of time range it searches over (LINEAR_TERM=10*1440), plus a baseline overhead of 5 seconds (CONSTANT_TERM=5*1440), and it is desired that queries be sub-divided only if they exceed a two-day time range, then the quadratic term is chosen to be 2.5*1440*1440 since at that setting the total cost for a two-day query is the same whether the original query is divided into two sub-queries or not. More complex cost functions may be used to express costs for crossing Saturday night boundaries or other factors that might affect the performance of the travel planning computers.

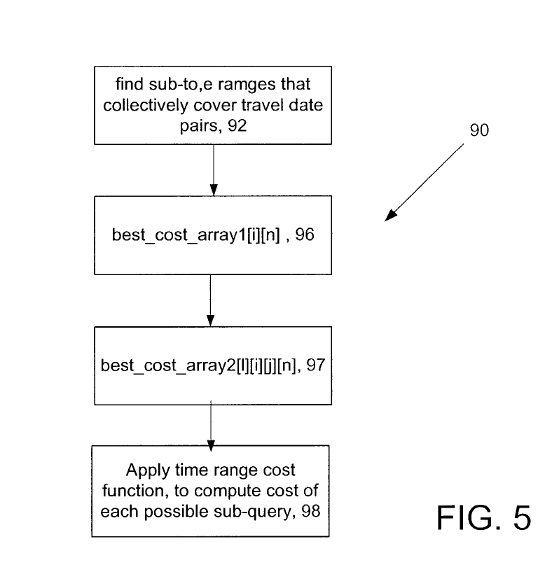

Referring to FIG. 5, a process 90 for dividing multiple time ranges is shown. The process is an extension of the single-time-range process 70 described above. The multiple-time-range algorithm simultaneously divides a round-trip query with flexible travel dates for both the outbound and the return portions of the trip. Assume that a query is posed “from BOS to LAX depart any time from Monday the 1st through Tuesday the 9th, return any time from Thursday the 4th through Thursday the 11th, staying over from 2 to 3 nights.” The possible travel dates for this query are represented by Xs in the following Table 1:

TABLE 1

| RE- | OUTBOUND | | | | | | | | |
|---|---|---|---|---|---|---|---|---|---|
| TURN | Mon | | Wed | | | | | Mon | |
| 0 | 1 | Tue 2 | 3 | Thu 4 | Fri 5 | Sat 6 | Sun 7 | 8 | Tue 9 |
| Thu 4 | X | X | — | — | — | — | — | — | — |
| Fri 5 | — | X | X | — | — | — | — | — | — |
| Sat 6 | — | — | X | X | — | — | — | — | — |
| Sun 7 | — | — | — | X | X | — | — | — | — |
| Mon 8 | — | — | — | — | X | X | — | — | — |
| Tue 9 | — | — | — | — | — | X | X | — | — |
| Wed 10 | — | — | — | — | — | — | X | X | — |
| Thu 11 | — | — | — | — | — | — | — | X | X |

The algorithm 90 splits this query as represented in the table into multiple sub-queries, e.g., from 1 to N sub-queries by finding 92 sub-rectangles (sub time-ranges for outbound and return) that collectively cover all the possible travel date-pairs (X's in the table above). The process 90 attempts 94 to minimize total cost as determined by an arbitrary sub-query cost function. Continuing the example, for a certain sub-query cost function this set of travel dates is divided into 3 sub-queries as represented in Table 2 by numbers 1, 2, 3.

TABLE 2

| | OUTBOUND | | | | | | | | |
|---|---|---|---|---|---|---|---|---|---|
| RE- | Mon | | Wed | | | | | Mon | |
| TURN | 1 | Tue 2 | 3 | Thu 4 | Fri 5 | Sat 6 | Sun 7 | 8 | Tue 9 |
| Thu 4 | 1 | 1 | 1 | — | — | — | — | — | — |
| Fri 5 | 1 | 1 | 1 | — | — | — | — | — | — |
| Sat 6 | — | — | 2 | 2 | 2 | 2 | — | — | — |
| Sun 7 | — | — | 2 | 2 | 2 | 2 | — | — | — |
| Mon 8 | — | — | 2 | 2 | 2 | 2 | — | — | — |
| Tue 9 | — | — | — | — | — | 3 | 3 | 3 | 3 |
| Wed 10 | — | — | — | — | — | 3 | 3 | 3 | 3 |
| Thu 11 | — | — | — | — | — | 3 | 3 | 3 | 3 |

This process 90 is a variation of the Viterbi algorithm, which although is not guaranteed to find the minimum cost solution usually does. The process 90 maintains two tables/One table that is maintained 96 is best_cost_array1[i][n] which holds the minimum cost division into n sub-queries of the rectangular region covering the entire outbound range and the return range up to but not including the time with index i, as represented by the X's in Table 3 below:

TABLE 3

| RETURN 0 | OUTBOUND |
|---|---|
| | XXXXXXXXXXXXXXXXXXXXXXXXXXXXXXXXXXXXXXXX |
| | XXXXXXXXXXXXXXXXXXXXXXXXXXXXXXXXXXXXXXXX |
| | XXXXXXXXXXXXXXXXXXXXXXXXXXXXXXXXXXXXXXXX |
| | XXXXXXXXXXXXXXXXXXXXXXXXXXXXXXXXXXXXXXXX |
| i | ....................................... |
| | ....................................... |
| | ....................................... |
| | ....................................... |

A second table maintained 97 is best_cost_array2[l][i][j][n], which holds the minimum cost division into n sub-queries of a stair step region represented by the X's in Table 4 below:

Table 4

| RETURN 0 | OUTBOUND |
|---|---|
| | XXXXXXXXXXXXXXXXXXXXXXXXXXXXXXXXXXXXXXXX |
| | XXXXXXXXXXXXXXXXXXXXXXXXXXXXXXXXXXXXXXXX |
| | XXXXXXXXXXXXXXXXXXXXXXXXXXXXXXXXXXXXXXXX |
| | XXXXXXXXXXXXXXXXXXXXXXXXXXXXXXXXXXXXXXXX |
| i | XXXXXXXXXXXXXX.......................... |
| | XXXXXXXXXXXXXX.......................... |
| j | ........................................ |
| | ........................................ |

The time units may be chosen arbitrarily, for example minutes or hours or days. For convenience it is assumed that the arbitrary time_ranges_cost( ) function used to measure the cost of a sub-query returns 0 if and only if the sub-query covers no valid travel times.

A detailed example of the process is shown below in Text boxes 3-5.

Text Box 3

```
get_optimal_time_range_pair_division(query_earliest_time1,
                      query_latest_time1,
                      query_earliest_time2,
                      query_latest_time2,
                      max_subqueries)
{
  let range1 = query_latest_time1 − query_earliest_time1,
  let range2 = query_latest_time2 − query_earliest_time2;
  let best_cost_array1 = array[range2][max_subqueries+1],
  let best_answer_array1 = array[range2][max_subqueries+1];
  let best_cost_array2 =
array[range1][range2][range2][max_subqueries+1];
  let best_answer_array2 =
array[range1][range2][range2][max_subqueries+1];
  best_cost_array1[][] = infinity;
  best_cost_array2[][][][] = infinity;
  for (j from 0 to range2) {
    for (i from 0 to j) {
      for (l from 0 to range1) {
        for (k from 0 to l) {
          for (n from 0 to max_subqueries) {
            let prev_cost = infinity;
            let prev_answer = {};
            let this_cost = time_ranges_cost(query_earliest_time1+k,
                        query_earliest_time1+1−1,
                        query_earliest_time2+i,
                        query_earliest_time2+j−1);
            let this_answer = { query_earliest_time1+k,
                query_earliest_time1+1−1,
                query_earliest_time2+i,
                query_earliest_time2+j−1 };
```

Text Box 4

```
if (k = 0) {
              if (i = 0) {
                if (n = 0) {
                  prev_cost = 0;
                  prev_answer = {};
                }
              }
              else {
                prev_cost = best_cost_array1[i][n];
                prev_answer = best_answer_array1[i][n];
              }
            }
            else {
              prev_cost = best_cost_array2[k][i][j][n];
              prev_answer = best_answer_array2[k][i][j][n];
            }
            if (prev_cost < infinity) {
              let new_cost = prev_cost;
              let new_answer = prev_answer;
              let new_n = n;
              if (this_cost > 0) {
                new_cost = prev_cost + this_cost;
                new_answer = append(prev_answer, this_answer);
                new_n = n + 1;
              }
              if (new_n < max_subqueries) {
                if (new_cost < best_cost_array2[l][i][j][new_n]) {
                  best_cost_array2[l][i][j][new_n] = new_cost;
                  best_answer_array2[l][i][j][new_n] = new_answer;
                }
                if (1 = range1 and new_cost <
best_cost_array1[j][new_n]) {
                  best_cost_array1[j][new_n] = new_cost;
                  best_answer_array1[j][new_n] = new_answer;
                }
              }
            }
          }
        }
      }
    }
  }
```

```
Text Box 5
// select out and return the number of sub-queries that results in
  // the lowest cost
  let best_cost = infinity;
  let best_answer = {};
  for (n from 1 to number_of_sub_queries) {
    if (best_cost_array1[range2][n] < best_cost) {
      best_cost = best_cost_array[range2][n];
      best_answer = best_answer_array[range2][n];
    }
  }
  return best_answer;
}
time_ranges_cost(query_earliest_time1, query_latest_time1,
        query_earliest_time2, query_latest_time2)
{
  // compute cost of sub-query, returning 0 if doesn't encompass
  // valid query times
  let d = number_of_valid_query_days(query_earliest_time1,
                query_latest_time1,
                query_earliest_time2,
                query_latest_time2);
  if (d = 0) return 0;
  let cost =
      CONSTANT_TERM +
      LINEAR_TERM * d +
      QUADRATIC_TERM * d * d;
  return cost;
}
```

This process 90 is slightly more expensive to run than process 70. Here the time_ranges_cost( ) function takes a pair of time ranges.

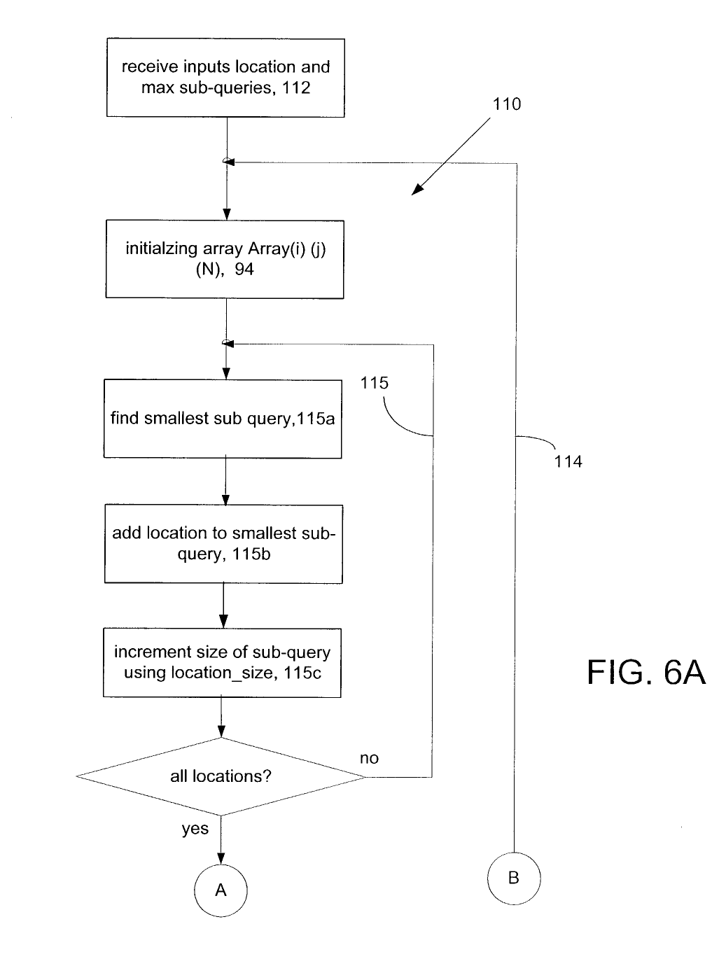

Referring to FIGS. 6A-6B, a process 110 for dividing a query into sub-queries according to a set of locations is shown. The process 110 receives 112 as inputs locations and a maximum number of sub-queries. The process 110 iterates 114 over the maximum number of sub-queries, N, initializing114a an array of N sub-queries. The process also iterates 115 over an inner loop based on locations to find the smallest sub-query 115a. The process 110 adds 115b location to smallest sub-query and increments 115c the size of sub-query using the location_size( ). The process 110 calculates 116 the total cost of all sub-queries using a cost function, location_bin_cost( ) function to calculate cost of each sub-query. The process 110 returns 118 answer for number of sub-queries that results in the smallest cost and outputs 119 the sub-queries.

For flexible destination queries, such as “from BOS, round trip to any destination in Europe” it may be advantageous to divide into sub-queries by grouping destination locations. For example, one might divide the airports within Europe by country, allocating one sub-query per destination country.

For travel planning systems that do not take share work when processing multiple locations, the primary concern with dividing a query into sub-queries is to ensure that each sub-query requires approximately the same amount of computer processing resources. If a function location_size( ) is available that independently estimates the cost of adding each location to a query, then optimally dividing the locations becomes a variation of the “bin packing” problem. Optimal bin packing is never complete, but there are many well-known approximation algorithms for solving this problem. The algorithm for solving this problem given immediately below, get_locations_division( ), like the time-range division algorithms given previously, incorporates a cost function location_bin_cost( ) that is assumed to be monotonically increasing:

An example is shown in Text Boxes 6 and 7 below.

Text Box 6

```
get_locations_division(locations, max_subqueries)
{
  let best_cost = infinity;
  let best_answer = {};
  for (n from 1 to max_subqueries) {
      let answer_pair = get_locations_division_of_{—}
      fixed_size(locations,
n);
      if (first(answer_pair) < best_cost) {
        best_cost = first(answer_pair);
        best_answer = second(answer_pair);
      }
    }
    return best_answer;
}
get_locations_division_of_fixed_size(locations,
number_of_subqueries)
{
  let n_locations = size(locations);
  let bin_size_array = array[n_locations];
  let bin_locations_array = array[n_locations];
  bin_size_array[] = 0;
  bin_locations_array[] = {};
  for (l from 0 to n_locations − 1) {
    let location = locations[l];
    let location_size = location_size(location);
    let min_bin = 0;
    let min_bin_size = size_array[0];
    for (b from 1 to number_of_subqueries − 1) {
      if(bin_size_array[b] < min_bin_size) {
        min_bin = b;
        min_bin_size = bin_size_array[b];
      }
    }
    bin_size_array[min_bin] = size_array[min_bin] + location_size;
    bin_locations_array[min_bin] =
    append(bin_locations_array[min_bin],
                        location);
}
let total_cost = 0;
let query_location_bins = {};
for (b from 0 to number_of_subqueries − 1) {
  let bin_size = bin_size_array[b];
  let bin_locations = bin_locations_array[b];
```

Text Box 7

```
    total_cost = total_cost + location_bin_cost();
    query_location_bins =
    append(query_location_bins, bin_locations);
  }
  return pair(total_cost, query_location_bins);
}
location_bin_cost(bin_size)
{
  let cost =
        CONSTANT_TERM +
        LINEAR_TERM * bin_size +
        QUADRATIC_TERM * (bin_size * bin_size);
  return cost;
}
```

Here the function location_size(location) should return an estimate of the additive cost of adding a particular location, such as an airport, to a sub-query. It might, for example, return the number of departures from the airport in one day. The location_bin_cost(bin_size) function takes as input the total size of a set of locations in a sub-query and returns an estimate of the cost of executing the sub-query. As with the time_range_cost( ) function, the QUADRATIC term favors equally sized sub-queries and the balance between the CONSTANT_TERM and the QUADRATIC_TERM can be used to control the number of sub-queries chosen.

If a travel planning system shares work across destinations, then it is advantageous to use more sophisticated methods for grouping locations, so as to maximize the work shared. For example, in such travel planning systems that share work across destinations much of the effort involved in pricing multiple flight combinations is shared if the flight combinations overlap. In this case when dividing the query it may be advantageous to group destinations that share sub-routes. Thus, for example, for a query from Boston to cities on the west coast of the United States, it may be advantageous to group small airports by the hub airports (San Francisco, Los Angeles, Phoenix, and so forth) they are most strongly connected to. This problem is closely related to other problems of “clustering”, and there are many techniques and algorithms for clustering that can be adapted for it.

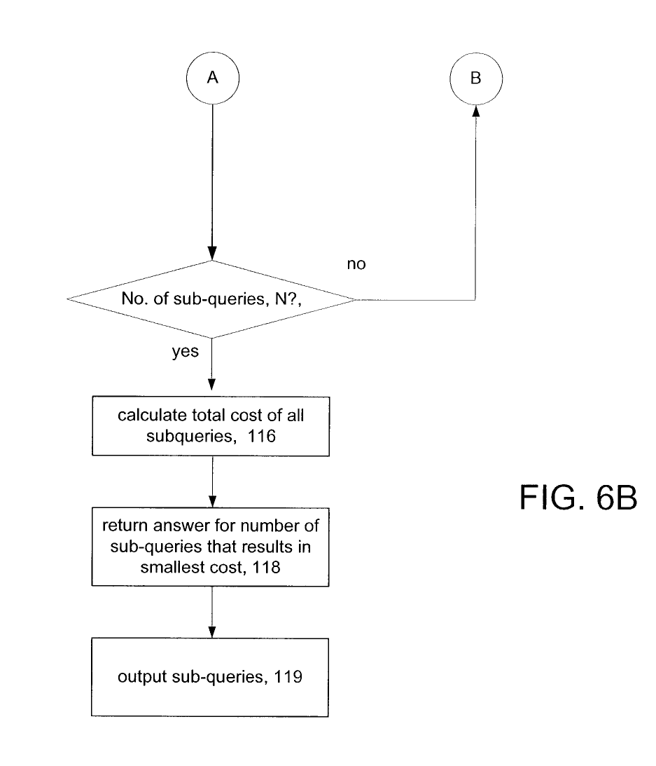

Referring to FIG. 7, a process 130 for dividing by both time and locations is shown. The process 130 receives 132 as inputs criterion 1 specification, criterion 2 specification and the maximum sub-queries. The process 130 calculates 134 for each number of sub-queries N1 the cost of dividing the query into N1 sub-queries based on criterion 1 and also calculates 136 for each number of sub-queries N2 the cost of dividing query into n2 sub-queries based on criterion 2. The process 130 finds 138 combination of N1 and N2 such that N1*N2 is less than or equal to maximum sub-queries that minimizes total cost. The process generates 140 a division of the query into sub-queries as cross product of division of criterion 1 into n1 sub-queries and criterion 2 into N2 sub-queries. The process 130 outputs the sub-queries.

For some queries it may be advantageous to divide queries into sub-queries based on more than one criterion simultaneously. For example, for queries involving both flexible travel dates and flexible destinations (“from BOS to any destination in Europe sometime this winter”) it may be desirable to split both the original query's time range and its destinations. This can be accomplished by assuming independence between the costs of two dimensions and taking advantage of the fact that the various algorithms described above for finding the optimal divisions of single criteria(get_optimal_single_{1—}time₁₃ range_division, get_optimal_time_range_pair_division and get_locations_division) compute the costs for variable numbers of sub-queries.

The following sample algorithm is for the case of dividing locations and a time range simultaneously. It assumes a variation of get_optimal_single_time_range_division (get_optimal_single_time_range_division X, presented below) that returns the best division and associated cost for each number of sub-queries, and similarly for get_locations_division.

The sample is shown in Text Boxes 8-10 below.

Text Box 8

```
get_optimal_simultaneous_divisions(earliest_time,
                    latest_time,
                    locations,
                    max_subqueries)
{
  // compute the best ways of dividing times and locations among
  // various numbers of processors
  let <best_time_cost_array, best_time_answer_array> =
    get_optimal_single_time_range_division_X(earliest_time,
                            latest_time,
                            max_subqueries);
  let <best_loc_cost_array, best_loc_answer_array> =
    get_location_division_X(locations, max_subqueries);
  // find the best pair of division sizes whose produce is less than
  // the maximum number of queries
  let best_pair = {}
  let best_cost = infinity;
  for (int n1 from 1 to max_subqueries) {
    for (int n2 from 1 to max_subqueries / n1) {
      let cost1 = best_time_cost_array[n1];
      let cost2 = best_loc_cost_array[n2];
      let cost = cost1 * cost2;
      if (cost < best_cost) {
        best_answer = pair(n1, n2);
        best_cost = cost;
      }
    }
  }
  // generate the final divison by taking the cross produce of time and
  // location divisions
  let answer = {};
  let n1 = first(best_pair);
  let n2 = second(best_pair);
  for (i from 1 to n1) {
    for (j from 1 to n2) {
      answer = append(answer, pair(best_time_answer_array[i],
                    best_loc_answer_array[j]));
    }
  }
  return answer;
}
```

Text Box 9

```
get_optimal_single_time_range_division_X(query_earliest_time,
                        query_latest_time,
                        max_subqueries)
{
  let query_time_range = query_latest_time −
  query_earliest_time + 1;
  // best_cost_array[i][n] holds the lowest possible total cost of
  // dividing the time from query_earliest_time to
  // query_earliest_time+i−1 into n sub-queries
  // best_answer_array[i][n] holds a particular way of dividing the
  // time to achieve this cost
  let best_cost_array = array[query_time_range][max_subqueries+1];
  let best_answer_array =
  array[query_time_range][max_subqueries+1];
  best_cost_array[][] = infinity;
  best_cost_array[0][0] = 0;
  best_answer_array[0][0] = {};
  for (i from 0 to query_time_range) {
    for (j from i+1 to query_time_range) {
      let time_window = pair(query_earliest_time+i,
                    query_earliest_time+j);
      let time_window_cost =
      time_range_cost(query_earliest_time+i,
                          query_earliest_time+j);
      for (n from 1 to max_subqueries) {
        let cost = best_cost_array[i][n−1] + time_window_cost;
        if (cost < best_cost_array[j][n]) {
          best_cost_array[j][n] = cost;
          best_answer_array[j][n] =
          append(best_answer_array[i][n−1],
                            time_window);
        }
      }
  }
}
// return the final result indexed by number of sub-queries
let final_best_cost_array = array[max_subqueries+1];
let final_best_answer_array = array[max_subqueries+1];
for (n from 1 to max_subqueries) {
  final_best_cost_array[n] = best_cost_array[query_time_range, n];
  final_best_answer_array[n] =
  best_answer_array[query_time_range, n];
}
return pair(final_best_cost_array, final_best_answer_array);
```

Text Box 10

```
get_locations_division_X(locations, max_subqueries)
{
  let final_best_cost_array = array[max_subqueries+1];
  let final_best_answer_array = array[max_subqueries+1];
  for (n from 1 to max_subqueries) {
    let answer_pair = get_locations_division_of_fixed_size(locations,
n);
    best_cost_array[n] = first(answer_pair);
    best_answer_array[n] = second(answer_pair);
  }
  return pair(final_best_cost_array, final_best_answer_array);
}
```

many different types of queries from different users. For example, at any moment computers within the farm may be answering a distribution of queries including scheduling queries, pricing queries and low-fare-search queries, and the low fare search queries may be of a wide variety of complexities, ranging from LFS queries with short-duration time windows and single-airport destinations to multi-month queries with many possible destinations.

In such a system, it is preferable that computational resources be devoted in proportion to queries' importance and difficulty. In addition, since the farm of computers is finite, it is necessary to limit the resources expended on queries to the total resources available. Thus, when the query rate is low it may be possible to devote many computers to each query, but near peak load it may be necessary to limit each query to a single computer.

The algorithms described above offer two mechanisms to control the number of computers used for a query (i.e., the number of sub-queries a query is divided into). The first is the max_subqueries argument, which is an absolute upper bound on the number of sub-queries for a query. The second is the cost function (time_range_cost, time_ranges_cost, location_bin_cost), in particular the constant component that assigns a base cost to every sub-query regardless of its size. Raising this component is likely to reduce the number of sub-queries chosen for a given query, and thus provides a mechanism for varying the average number of computers used to process queries. A travel planning system can dynamically alter the cost function (for the cost functions given above, through the parameter CONSTANT_TERM) in response to load to maximize the resources devoted to queries without exceeding the system's total computational resources. For example, the system may have a set of different cost function parameters and maximum sub-query limits that it uses for different load levels and levels of query priority as shown in Table 5 below:

| Load | | |
|---|---|---|
| level | Priority Level 1 | Priority Level 2 |
| 1 | CONSTANT_TERM = 2000 | CONSTANT_TERM = 1000 |
| | max subqueries = 10 | max subqueries = 20 |
| 2 | CONSTANT_TERM = 4000 | CONSTANT_TERM = 2000 |
| | max subqueries = 5 | max subqueries = 10 |
| 3 | CONSTANT_TERM = 10000 | CONSTANT_TERM = 4000 |
| | max subqueries = 2 | max subqueries = 4 |
| 4 | CONSTANT_TERM = 20000 | CONSTANT_TERM = 10000 |
| | max subqueries = 1 | max subqueries = 2 |

In Table 5 each row reflects parameters to be used when the travel planning system is experiencing a certain arbitrarily defined load level. Rows with higher load levels contain parameters that reduce site load by reducing the number of sub-queries that will be generated for a query. For example, a month-long flexible date query assigned to priority level 1 might be divided into 10 sub-queries under load level 1 whereas the same query assigned to priority level 2 and processed with load level 4 might result in only 2 sub-queries.

Here the priority is intended to reflect an external assignment of importance, such as to reflect the amount being paid for the query, or to favor certain users. The choice of which load level to use is adjusted by the travel planning system in accordance with the computational load it is experiencing. In one implementation, a monitoring process measures the proportion of computing resources used over a time span (perhaps 30 seconds). If the proportion exceeds some threshold (perhaps 90%) then the load level is incremented (reducing the average amount of computing resources used by future queries) and if it is below some level (perhaps 70%) then the load level is reduced (increasing the average amount of computing resources used by future queries, but presumably improving query latency or efficacy).

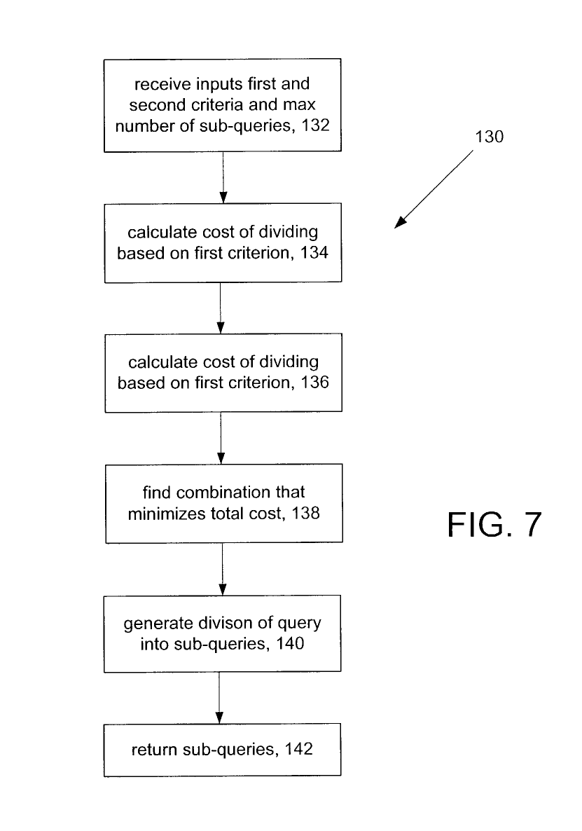

Referring to FIG. 8, a process 160 for dividing queries into sub-queries that accept parameters from a load monitoring process is shown. A query is processed 162 by a query division process that accepts parameters from a load monitoring process 164. As above, the parameters might include maximum number of sub-queries to divide the query into and other parameters such as the base cost of each sub-query (CONSTANT_TERM in the described above). These parameters might further be classified by query importance. The query division process 160 uses the parameters in its work to generate 166 a set of sub-queries to be executed by travel planning computers. The load monitoring process 164 continuously monitors 168 the computing resources in use and adjusts the parameters accordingly so as to maximize the resources used without exceeding the resources available.

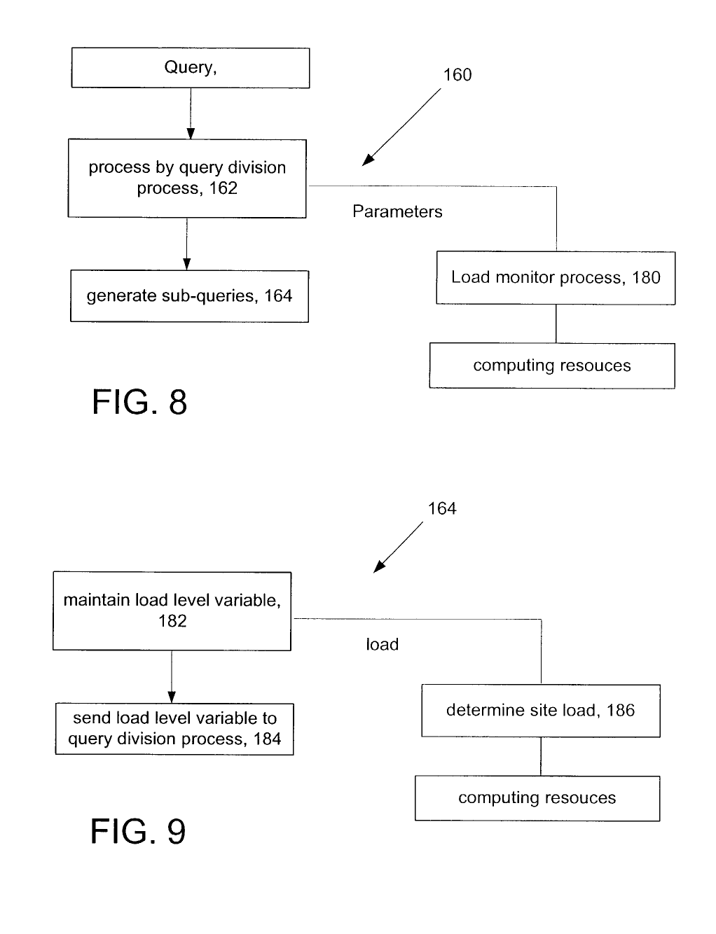

Referring to FIG. 9, an example of the load monitoring process 164 is shown. The explicit constants in the figure are representative only. The process 164 maintains and adjusts 182 a load level variable and sends 184 process parameters to the query division process. The parameters are provided from a table that is indexed by the load level. The monitoring process 180 takes as input 186, the site load, measured as the average proportion of computational resources used over the most recent time interval.

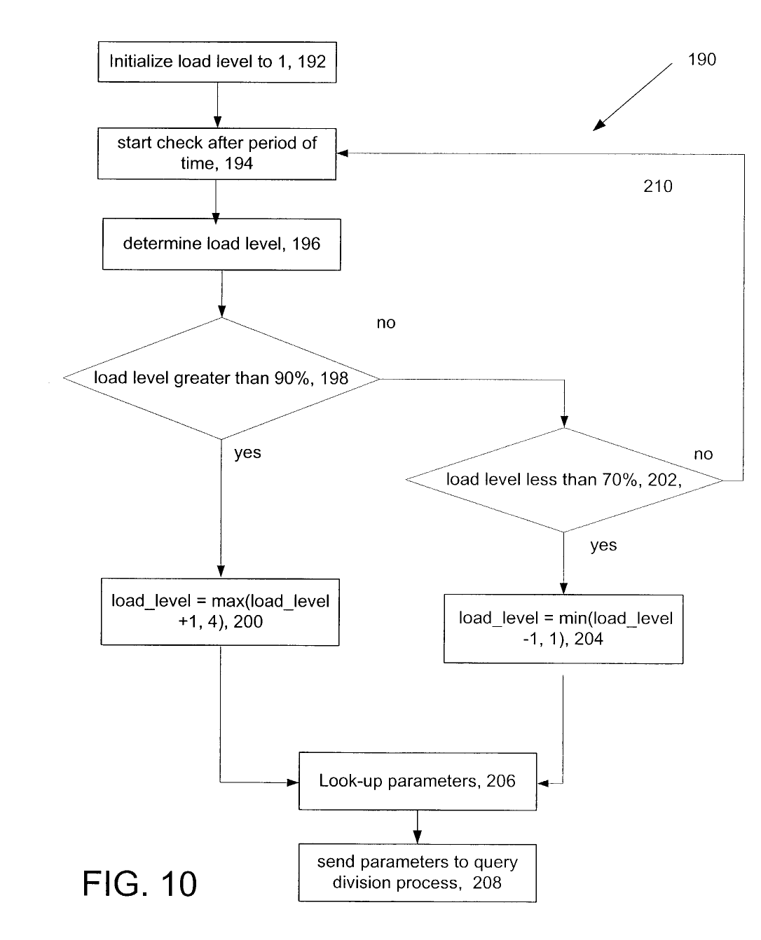

Referring to FIG. 10, an exemplary technique for a load monitoring process is shown 190. Load level parameter in the monitoring process is initialized 192 to “1.” The monitoring process starts 194 checking load every interval of time, e.g., 30 seconds. The site load 196 is determined. If the load is greater than 90% 198, the load_level is set 200 to max(load_level+1, 4). If the load is greater than 70%, 202 the load_level is set 204 to a min(load_level−1, 1). In either event, the parameters are looked 206 up in the parameters table indexed by the load_level and sent 208 to query division process. Otherwise, (if the loading is between 70 and 90 percent) the process returns 210 to perform another sampling. This is one technique for adjusting load and query importance. More sophisticated or substantially different techniques could also be used.

A number of embodiments of the invention have been described. Nevertheless, it will be understood that various modifications may be made without departing from the spirit and scope of the invention. Accordingly, other embodiments are within the scope of the following claims.

What is claimed is:

1. A method comprising:
dividing a travel query into sub-queries for execution by a travel planning system to return answers that satisfy the travel query.

2. The method of claim 1 wherein the travel query includes an input specification of origins and destinations and time range for different parts of a trip.

3. The method of claim 1 wherein the query is used with the travel planning system to produce an answer that includes flights that satisfy the query and fares that can be used with the flights.

4. The method of claim 1 further comprising:
concurrently executing the sub queries on different computers.

5. The method of claim 1 further comprising:
sequentially executing the sub queries on a single computer.

6. The method of claim 1 wherein the sub queries are provided by dividing the travel query according to a time range.

7. The method of claim 1 wherein the sub queries are provided by dividing the travel query according to a pair of time ranges.

8. The method of claim 1 wherein the sub queries are provided by dividing the travel query according to a set of locations.

9. The method of claim 1 wherein the sub queries are provided by dividing the travel query according to both a time range and a set of locations.

10. The method of claim 1 wherein the sub queries are provided by dividing the travel query according to a set of flight combinations.

11. The method of claim 1 wherein the sub queries are provided by dividing the travel query according to a set of fares or booking codes cabin classes.

12. The method of claim 1 wherein the sub queries are provided by dividing the travel query according to a set of carriers.

13. The method of claim 1 wherein the sub queries are provided by dividing the travel query in accordance with a cost of executing the sub-queries.

14. The method of claim 1 wherein the travel planning system is comprised of a plurality of planning computers that each execute travel planning application, and the sub queries are determined independently on each of the planning computers.

15. The method of claim 1 wherein the travel planning system is comprised of a plurality of planning computers that each execute travel planning application and a query distributor system, and the sub queries are determined on the query distributor system.

16. The method of claim 1 wherein the travel planning system is comprised of a plurality of planning computers that each execute travel planning application and a query distributor system coupled to a client system the is the source of the travel query, and the sub queries are determined on the client system.

17. A method comprising:
dividing a travel query into sub-queries according to a determined optimal division of the query for execution by a travel planning system to return answers that satisfy the travel query.

18. The method of claim 17 wherein dividing further comprises: using cost functions to arrive at a set of sub-queries that would balance work performed by the sub-queries through selecting values of term in the cost functions.

19. The method of claim 17 wherein the sub queries are optimized by taking into consideration the duration of time ranges or measures of airport size, measures of airline size, or estimates of query processing complexity.

20. The method of claim 17 wherein estimates of query processing complexity are presence of a Saturday-night stay or advanced purchase.

21. The method of claim 17 wherein the sub-queries are provided with multi-day ranges and multi-location sets.

22. The method of claim 17 wherein the sub-queries do not overlap.

23. A method comprising:
dividing a travel query into sub-queries according taking query difficulty into account for execution by a travel planning system to return answers that satisfy the travel query.

24. The method of claim 23 wherein taking query difficulty into account comprises varying the number of sub-queries by query difficulty.

25. The method of claim 23 wherein taking query difficulty into account comprises taking query importance into account.

26. The method of claim 23 wherein taking query difficulty into account comprises varying the number of sub-queries by query importance.

27. The method of claim 23 wherein taking query difficulty into account comprises taking system load into account.

28. The method of claim 23 wherein taking query difficulty into account comprises varying the number of sub-queries by system load.

29. The method of claim 23 further comprising:
monitoring loading of the computing resources;
adjusting parameters used in dividing the query into sub-queries to maximize the resources used without exceeding the available resources.

30. A computer program product residing on a computer readable medium comprises instructions for causing a computer to:
divide a travel query into sub-queries for execution by the computer that is part of a travel planning system to return answers that satisfy the travel query.

31. The computer program product of claim 32 wherein the travel query includes an input specification of origins and destinations and time range for different parts of a trip.

32. The computer program product of claim 32 wherein instructions to divide the query divide the query into the sub queries according to a time range.

33. The computer program product of claim 32 wherein instructions to divide the query divide the query into the sub queries according to a pair of time ranges.

34. The computer program product of claim 32 wherein instructions to divide the query divide the query into the sub queries according to a set of locations.

35. The computer program product of claim 32 wherein instructions to divide the query divide the query into the sub queries according to both a time range and a set of locations.

36. The computer program product of claim 32 wherein instructions to divide the query divide the query into the sub queries according to a set of flight combinations.

37. The computer program product of claim 32 wherein instructions to divide the query divide the query into the sub queries according to a set of fares or booking codes cabin classes.

38. The computer program product of claim 32 wherein instructions to divide the query divide the query into the sub queries according to a set of carriers.

39. The computer program product of claim 32 wherein instructions to divide the query divide the query into the sub queries according to a cost of executing the sub-queries.

40. The computer program product of claim 32 wherein instructions to divide the query divide the query according to a determined optimal division of the query for execution by a travel planning system to return answers that satisfy the travel query.

41. A computer program product residing on a computer readable medium comprises instructions for causing a computer to:
divide a travel query into sub-queries according to, query difficulty for execution by a travel planning system, to return answers that satisfy the travel query.

42. The computer program product of claim 32 wherein instructions to divide comprises varying the number of sub-queries by query difficulty.

43. The computer program product of claim 32 wherein instructions to divide include instructions that take query difficulty into account to balance system load during execution of the sub-queries.
